(19) United States
(12) Patent Application Publication
(10) Pub. No.: US 2010/0258510 A1
(43) Pub. Date: Oct. 14, 2010

(54) METHODS AND APPARATUS FOR TREATING EFFLUENT

(75) Inventors: FRANK F. HOOSHDARAN, Pleasanton, CA (US); TETSUYA ISHIKATA, Saratoga, CA (US); JAY J. JUNG, Sunnyvale, CA (US); PHIL CHANDLER, Bristol (GB); DANIEL O. CLARK, Pleasanton, CA (US)

Correspondence Address: MOSER IP LAW GROUP / APPLIED MATERIALS, INC., 1030 BROAD STREET, SUITE 203, SHREWSBURY, NJ, 07702, US

(73) Assignee: APPLIED MATERIALS, INC., Santa Clara, CA (US)

(21) Appl. No.: 12/755,737

(22) Filed: Apr. 7, 2010

Related U.S. Application Data
(60) Provisional application No. 61/168,461, filed on Apr. 10, 2009.

(51) Int. Cl. B01D 35/00

(52) U.S. Cl. 210/749; 210/198.1

(57) ABSTRACT

Methods and apparatus for treating effluents in process systems are provided In some embodiments, a system for treating effluent includes a process chamber having a processing volume; an exhaust conduit coupled to the process chamber to remove an effluent from the processing volume; and a reactive species generator coupled to the exhaust conduit to inject a reactive species into the exhaust conduit to treat the effluent, wherein the reactive species generator generates a reactive species comprising at least one of singlet hydrogen, hydrogen ions or hydrogen radicals. In some embodiments, a method for treating effluent includes flowing an effluent from a processing volume of a process system through an exhaust conduit fluidly coupled to the processing volume; treating the effluent in the exhaust conduit with a reactive species comprising at least one of singlet hydrogen, hydrogen ions, or hydrogen radicals; and flowing the treated effluent to an abatement system.

### CROSS-REFERENCE TO RELATED APPLICATIONS

This application claims benefit of U.S. provisional patent application Ser. No. 61/168,461, filed Apr. 10, 2009, which is herein incorporated by reference in its entirety.

### FIELD

Embodiments of the present invention generally relate to methods and equipment for treating effluent.

### BACKGROUND

Effluents generated in, for example, a semiconductor, display, solar, or light emitting diode (LED) manufacturing process requires treatment prior to being released into the environment. Exemplary effluents may include perfluorocarbons, nitrogen oxides, and the like. Exemplary treatments of the effluents may include combustion and/or thermal treatment of the effluent using a fuel, such as methane, propane, or the like. Unfortunately, fuels for combustion, such as hydrocarbon fuels can be a safety hazard, which could result in fire or explosion. Further, hydrocarbon fuels can undesirably increase carbon foot print due to resultant byproducts from combustion, such as carbon monoxide (CO), carbon dioxide (CO₂), or the like. In addition, the infrastructure costs related to providing, storing, and delivering needed fuel for treatment of the effluent may be prohibitively expensive in certain regions where such manufacturing processed occur.

Accordingly, there is a need in the art for improved methods and apparatus for treating effluent.

### SUMMARY

Methods and apparatus for treating effluents in process systems are provided herein. In some embodiments, a system for treating effluent may include a process chamber having a processing volume; an exhaust conduit coupled to the process chamber to remove an effluent from the processing volume; and a reactive species generator coupled to the exhaust conduit to inject a reactive species into the exhaust conduit to treat the effluent, wherein the reactive species generator generates a reactive species comprising at least one of singlet hydrogen, hydrogen ions or hydrogen radicals.

In some embodiments, a method for treating effluent may include flowing an effluent from a processing volume of a process system through an exhaust conduit fluidly coupled to the processing volume; treating the effluent in the exhaust conduit with a reactive species comprising at least one of singlet hydrogen, hydrogen ions, or hydrogen radicals; and flowing the treated effluent to an abatement system.

The above brief summary is not intended to be limiting of the invention. Other and further embodiments are discussed below in the detailed description section of the application.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic of a process system in accordance with some embodiments of the present invention.

FIGS. 2A-E depict variants of an exhaust conduit in accordance with some embodiments of the present invention.

FIG. 3 depicts a flow chart for a method of treating an effluent in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Methods and apparatus for treating effluents in a process system are disclosed herein. The inventive methods and apparatus advantageously improve abatement efficiency and reduce carbon foot print.

Embodiments of the present invention relate to the use of hydrogen (or in situ, e.g., locally generated, hydrogen) to assist in the abatement of process effluent, perfluorocarbons, and NF₃. The presence of singlet hydrogen (H) and/or hydrogen radicals have unexpectedly been discovered to be effective in catalyzing the thermal decomposition of exhaust emissions, perfluorocarbons (PFC), and NF₃ more efficiently and at lower furnace temperatures than conventional oxidation. This was demonstrated at AMAT R&D facilities where stoichiometrically low amounts of hydrogen addition to PFC abatement devices exhibited surprisingly high destruction removal efficiencies (DRE) of PFC's, or other species requiring reduction, relative to normal expectations.

Thus, the inventors have proposed the use of plasma hydrogen injection inlets to abatement devices such that energized singlet and hydrogen radicals are mixed with incoming effluents to afford exceptional destruction removal/conversion efficiency. Methods to provide and mix a stream of energized radical or singlet hydrogen to the effluent stream containing species either pre-pump (affording pre pump DRE), at the pump, or post-pump vary.

For example, In some embodiments, concentric annuals (e.g., conduits) may be provided with the effluent being in the lumen of the inner conveyance and the energized reagent being introduced though the outer conveyance. Mixing occurs immediately downstream. In some embodiments, concentric annuals may be provided with the energized reagent introduced through the lumen of the inner conveyance and the effluent introduced through the outer conveyance. Mixing occurs immediately downstream. In some embodiments, tangential or angled injection of the reagent into the effluent may be provided to encourage mixing. In some embodiments, tangential or angled injection of the effluent to the reagent may be provided to encourage mixing. In these examples, the relative lengths of the various concentric annuli may vary. In some instances, the inner annulus may be shorter or longer than the exterior annulus to afford optimal abatement performance and minimize deposits or erosion of said conveyance.

In some embodiments, a concentric annular sleeve may be provided about the exhaust conduit to allow an inert gas sleeve to be provided between the effluent and the reagent until both species are in the reactor and a distance from the physical inlet assembly. Such a configuration minimizes deposits and very high temperatures at the ends of the conveyance apparatus.

The methods to make the hydrogen and or hydrogen/oxygen source available vary. For example, in some embodiments, Atomic Hydrogen Welding (AHW) (examples include use of high voltage and electrodes, such as tungsten electrodes) is one method for providing energized singlet hydrogen and energized hydrogen radicals. AHW apparatus may locally generate the energized hydrogen for mixing into the effluent stream either pre-, within, or post-pump to improve destruction removal or conversion efficiency. In some embodiments, a capacitive, inductive, ark, microwave, or standing wave plasma may be utilized to dissociate hydrogen or water and form energized radicals to assist in effluent abatement and the reduction of GWP (Global Warming Products).

In some embodiments, Brown's gas (HHO gas) may be utilized to form preferential species in situ to facilitate efficient abatement. HHO, also known as Brown's gas, oxygen-hydrogen, or hydroxy gas, has about 3.8 times the possible heat energy than an H₂ and O₂ flame and each liter of water can expand into 1866 liter of combustible gas. HHO can replace the use of methane or other abatement fuel gases with no adverse impact on the environment with no danger of storage, transport, or use. In some embodiments, electrical energy may be utilized to form the hydrogen or hydrogen oxygen mixture locally, thus minimizing the volume and transport distance. Such methods and apparatus minimize the risk of fire due to use of large volumes or high pressure flammable gases. Brown's gas generators or conventional electrolysis equipment are examples of apparatus for forming hydrogen locally.

For example, in some embodiments, a fuel generator may use electricity to electrolyze water into pure hydrogen and oxygen close to point of use. The Oxy-hydrogen gas may be routed through a filter and pressure detector to a flame device (with anti-back-fire safety valve) and through nozzles to ignite the gas to a temperature between 800 and 4000 degrees centigrade at the desired abatement location in the reactors. The use of flash back arrestors, engineering design, pressure gradients, temperature control, and gas flow velocities can be used to manage local flammability issues.

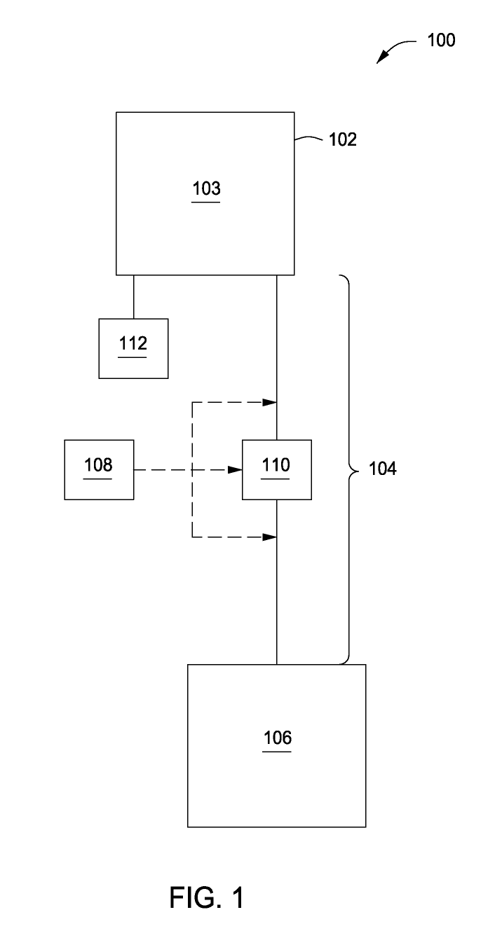

An exemplary processing system 100 is schematically illustrated in FIG. 1. The processing system 100 includes a process chamber 102 having a processing volume 103 coupled to an abatement system 106 via an exhaust conduit 104. An effluent, such as a process gas, reactive species, etching byproduct, or the like may be exhausted from the processing volume 103 to the abatement system 106. Exemplary effluents include, but are not limited to, perfluorocarbons, nitrogen trifluoride (NF₃), and/or nitrogen oxides (NOₓ). A reactive species generator 108 may be coupled to the exhaust conduit 104 for forming and delivering a reactive species to the exhaust conduit 104, where the reactive species treats the effluent, for example, by converting the effluent to a more desirable form for exhaust into the environment and/or for further abatement processing. The treated effluent may then be further processed in the abatement system 106, for example, by burning, scrubbing, or another suitable abatement process. The reactive species may be generated within the flow of the effluent stream in the exhaust conduit 104 or generated exterior to conveyance connector 104 and injected pre, post, or within the post-chamber pump.

For example, a pump 110 may be disposed in the exhaust conduit 104 for removing the effluent from the processing volume 103 and for flowing the effluent through the exhaust conduit 104 to the abatement system. As illustrated in FIG. 1, the reactive species generator 108 may couple to the exhaust conduit 104 between the process chamber 102 and the pump 110, between the pump 110 and the abatement system 106, or at the pump 110. Further, and not shown, the reactive species generator 108 can be coupled to the abatement system 106 or part of the abatement system 106. The reactive species generator or reactive species injector may be coupled directly to the reaction chamber or inlets to the reaction chamber (e.g., the reaction chamber of the abatement system).

A controller 112 may be coupled to the process chamber 102 for controlling the operation thereof, and further controlling the operation of the system 100. Alternatively, and not shown, the controller may be coupled to the abatement system 106 and the reactive species generator 108, or to individual controllers (not shown) of the abatement system 106 and generator 108 for controlling the respective operations thereof. The semiconductor processing system 100 described above is merely exemplary and other processing systems are possible, for example, a processing system having two or more process chambers coupled to the same abatement system, a process chamber coupled to multiple abatement systems, where each abatement system may be configured for processing a specific effluent, or the like.

The process chamber 102 may be any chamber where effluent including perfluorocarbons (PFCs), nitrogen trifluoride (NF₃), nitrogen oxide, or any other hazardous air pollutants (HAPS) is present. In some embodiments, the process chamber 102 may be any suitable chamber for processing and/or manufacturing of semiconductors, displays, solar panels, light emitting diodes (LED), or the like (although process chambers or reactors utilized in other industries are specifically contemplated). For example, the process chamber 102 may be configured for performing gas phase or liquid phase processes. Non-limiting examples of such gas phase processes may include dry chemical etching, chemical vapor deposition, physical vapor deposition, plasma etching, plasma oxidation, plasma nitridation, rapid thermal oxidation, epitaxial deposition, and the like. Non-limiting examples of such liquid phase processes may include wet chemical etching, physical liquid deposition and the like. An exemplary process chamber 102 may, for example, include a substrate support, gas panel for providing one or more process gases, and a means of distributing the process gases in the process chamber, for example, a showerhead or nozzle. The chamber may be configured for providing a capacitively coupled, inductively coupled, or remote plasma. The chamber may include one or more heating lamps, for example, when configured for a rapid thermal process (RTP) or epitaxial deposition process. Although disclosed as a single processing chamber, processing systems having multiple process chambers (clustered or stand-alone) that are linked to a common exhaust may also be modified in accordance with the teachings provided herein.

The substrate processed in the process chamber 102 may be any suitable substrate processed in a process chamber. For example, the substrate may be any suitable material to be processed, such as crystalline silicon (e.g., Si<100> or Si<111>), silicon oxide, strained silicon, silicon germanium, doped or undoped polysilicon, doped or undoped silicon wafers, patterned or non-patterned wafers, silicon on insulator (SOI), carbon doped silicon oxides, silicon nitride, doped silicon, germanium, gallium arsenide, glass, sapphire, a display substrate (such as a liquid crystal display (LCD), a flat panel display (FPD), a plasma display, an electro luminescence (EL) lamp display, or the like), a solar cell array substrate (such as a solar cell or solar panel), a light emitting diode substrate (such as an LED, OLED, FOLED, PLED, or the like), an organic thin film transistor, an active matrix, a passive matrix, a top emission device, a bottom emission device, or the like. The substrate may have various dimensions, such as 200 mm or 300 mm diameter wafers, as well as rectangular or square panels.

The process chamber 102 may be configured, for example, to deposit a layer of material on the substrate, to introduce a dopant to the substrate, to etch the substrate or a material deposited on the substrate, to otherwise treat the substrate, or the like. Such layers deposited on the substrate may include layers for use in a semiconductor device, for example, a metal oxide semiconductor field effect transistor (MOSFET) or a flash memory device. Such layers may include silicon-containing layers, such as polysilicon, silicon nitride, silicon oxide, silicon oxynitride, metal silicide, or alternatively, metal containing layers, such as copper, nickel, gold, or tin containing layers, or metal oxide layers, for example hafnium oxide. Other deposited layers may include, for example, sacrificial layers such as etch stop layers, photoresist layers, hardmask layers, and the like.

The process chamber 102 may use any suitable process gas and/or process gas mixture, for example, to form a layer atop the substrate, to remove material from the substrate, or to otherwise react with material layers exposed upon the substrate, or the like. Such process gases may include silicon-containing gases, such as silane (SiH₄), dichlorosilane (Cl₂SiH₂), or the like; and/or metal-containing gases, such as metalorganics, metal halides or the like. Other process gases may include inert gases, such as helium (He), argon (Ar), nitrogen (N₂), or the like; and/or reactive gases, such as halogen-containing gases, oxygen (O₂), hydrogen fluoride (HF), hydrogen chloride (HCl), hydrogen bromide (HBr), nitrogen trifluoride (NF₃) or the like.

Accordingly, any process gas or liquid, process gas or liquid mixture, substrate, deposited materials, removed materials, or combinations thereof may comprise and/or combine to form effluents that are exhausted from the process chamber. The effluents may include un-reacted or excess portions of a process gas or chemical agent used for processing the substrate or cleaning the chamber and/or chamber components such as re-usable process kits or process kit shields. The effluents generated in these processes can include different compositions of flammable and/or corrosive compounds, sub-micron sized process residue particulates and gas phase nucleated materials, and other hazardous or environmentally polluting compounds. For example, the effluent may contain different compositions of halogen containing gases, perfluorocompounds (PFCs), chlorfluorocompounds (CFCs), hazardous air products (HAPs), volatile organic compounds (VOCs), global warming gases (GWGs), flammable and toxic gases, and the like.

Effluents from the processing volume 103 exhausted via the exhaust conduit 104 may be treated prior to reaching the abatement system 106. For example, the treatment of an effluent, such as a PFC with a reactive species, such as a hydrogen radical, may convert the effluent into a desirable form, such as a shorter chain molecule, cleaved halogen, or other such form, that may be further processed at the abatement system 106 and/or exhausted into the environment.

The effluents can be treated by injecting a reactive species generated by the reactive species generator 108 into the exhaust conduit 104. The reactive species generator 108, for example, may be capable of one or more of the following processes to generate the reactive species: generating a capacitively coupled, inductively coupled, remote, or standing wave plasma, or an arcing process, such those arcing processes used in, for example, atomic hydrogen welding, or an electrolysis process, for example, such as those electrolysis processes used in, for example, a water torch or to create HHO, or Brown's gas. The reactive species can be generated from a fuel, such as hydrogen (H₂), oxygen (O₂), water (H₂0), or combinations thereof. In some embodiments, the fuel is hydrogen (H₂). In some embodiments, the fuel is water (H₂0). The reactive species generated from the fuel may include one or more of hydrogen (H₂), hydrogen ions (H⁺), hydrogen radicals, oxygen (O₂), oxygen ions (O⁻), oxygen radicals, oxyhydrogen (OH), oxyhydrogen radicals, or water (H₂O).

The reactive species may be injected into the exhaust conduit 104 to treat the effluent. As discussed above, the reactive species can be injected at one or more locations, such as upstream of the pump 110, within the pump 110, downstream of the pump 110, or into the abatement system 106. Optionally or additionally, the reactive species could be generated or injected into the inlets of the reactor (abatement system 106) or optionally directly into the reactor (abatement system 106).

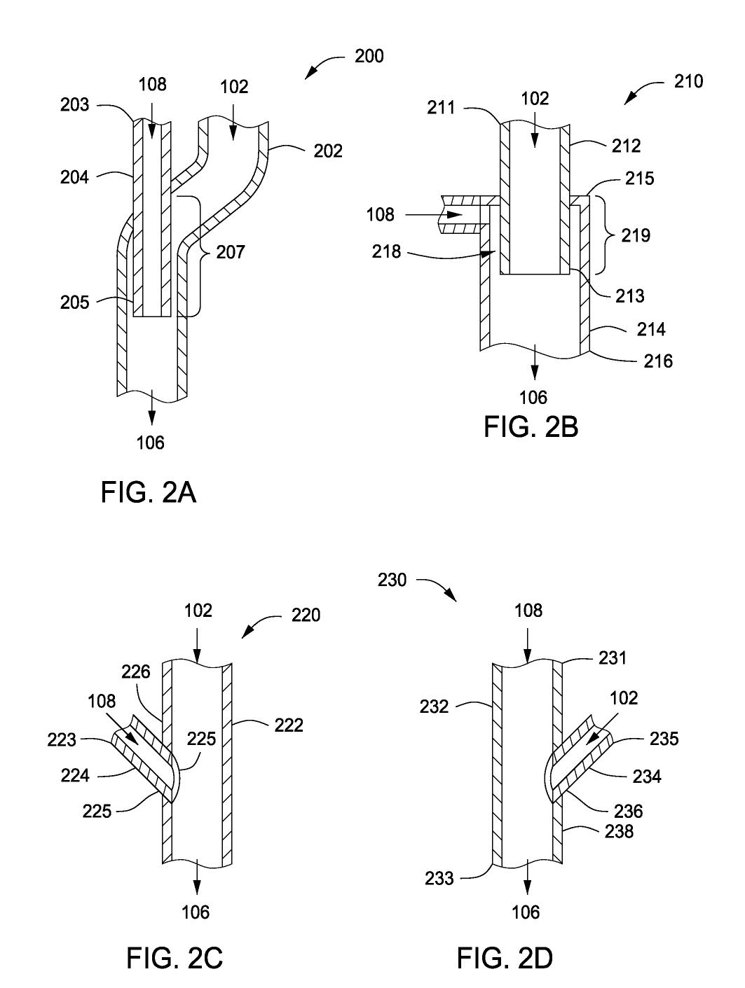

The reactive species may be injected in any suitable manner that facilitates efficient mixing of the reactive species with the effluent. For example, the reactive species may be introduced in a central location of the exhaust conduit (e.g., axially within the conduit), as an annular sheath surrounding a central flow of the exhaust (e.g., as a lumen or sheath surrounding the exhaust), or as one or more streams of reactive species in any other suitable location within the exhaust conduit. Non-limiting exemplary embodiments of a portion of an exhaust conduit including a reactive species introduction or generation points are depicted in FIGS. 2A-E. The embodiments may facilitate efficient mixing of the reactive species generated by the generator 108 and the effluents flowing in the exhaust conduit.

FIG. 2A depicts an exhaust conduit 200 in accordance with some embodiments of the present invention. The exhaust conduit 200 comprises a first conduit 202 for exhausting the effluent between the processing volume 103 of the process chamber 102 and the abatement system 106. A second conduit 204 enters the first conduit 202 and may be oriented substantially parallel thereto. The second conduit 204 is coupled to the generator 108 at a first end 203 of the second conduit. The second conduit further comprises a opposing end 205 disposed in the first conduit 202 and utilized for providing the reactive species into the first conduit 202. The first and second conduits may be concentrically disposed. For example, a portion 207 of the second conduit 204 may be disposed concentrically within in the first conduit 202. As illustrated in FIG. 2A, the portion 207 of the second conduit 204 includes the opposing end 205 of the second conduit 204.

FIG. 2B depicts an exhaust conduit 210 in accordance with some embodiments of the present invention. The exhaust conduit 210 comprises a first conduit 212 for exhausting the effluent into a second conduit 214. The first conduit 212 includes a first end 211 coupled to the process chamber 102 and a opposing end 213 for providing the effluent to the second conduit 214. The second conduit 214 includes a first end 215 for receiving the effluent from the first end 211 of the first conduit 212 and an opposing end 216 coupled to the abatement system 106. In some embodiments, the first and second conduit may be parallel and concentric as shown in FIG. 2B, where a portion 218 of the first conduit 212 that includes the opposing end 213 of the first conduit 212 is concentrically disposed within a portion 219 of the second conduit 214 which includes the first end 215 of the second conduit 214. The generator 108 may be coupled to the exhaust conduit 210 at the second conduit 214, for example proximate the first end 215 of the second conduit 214 as illustrated in FIG. 2B, for injecting the reactive species into the exhaust conduit 210. The second conduit 214 may be coupled to the abatement system 106 at the opposing end 216 of the second conduit 214.

FIG. 2C depicts an exhaust conduit 220 in accordance with some embodiments of the present invention. The exhaust conduit 220 includes a first conduit 222 for flowing the effluent between the processing volume 103 of the process chamber 102 and the abatement system 106. The reactive species may be injected using a second conduit 224. The second conduit 224 includes a first end 223 coupled to the generator 108 and an opposing end 225 coupled to the first conduit 222 at a wall 226 of the first conduit 222. The second conduit 224 may be disposed at an angle to the first conduit 222. The angle may be any suitable angle to facilitate mixing of the reactive species and the effluent, such as between about 0 to about 180 degrees with respect to a central axis (not shown) of the first conduit 222. In some embodiments, the second conduit 224 may be disposed tangentially to surface of the first conduit 222, for example, to facilitate creation of a vortex within the conduit to facilitate improved mixing of the reactive species and the effluent.

The second conduit 224 may also be angled with respect to the first conduit 222 along two directions. For example, two reference planes may be defined: a first reference plane containing the central axis of the first conduit 222 and the intersection point of the second conduit 224 and the first conduit 222, and a second reference plane normal to the first reference plane and also containing the central axis of the first conduit 222. The two angles may then be defined by a first angle between a central axis of the first conduit 222 and a central axis of the second conduit 224 projected upon the first reference plane, and a second angle between the central axis of the first conduit 222 and central axis of the second conduit 224 along the second reference plane.

FIG. 2D depicts an exhaust conduit 230 in accordance with some embodiments of the present invention. The exhaust conduit 230 includes a first conduit 232 which couples the generator 108 to the abatement system 106. The first conduit 232 includes a first end 231 coupled to the generator 108 and an opposing end 233 coupled to the abatement system 106. The effluents may be injected using a second conduit 234, where the second conduit 234 couples the processing volume 103 of the process chamber 102 to the first conduit 232. For example, the second conduit 234 includes a first end 235 coupled to the process chamber 102 and an opposing end 236 coupled to the first conduit 232 at a wall 238 of the first conduit 232. The first and second exhaust conduits 232, 234 may be configured similarly as described above with respect to the embodiments corresponding to FIG. 2C. For example, the second conduit 234 may be disposed at an angle to the first conduit 232 as illustrated in FIG. 2D.

FIG. 2E depicts an exhaust conduit 240 in accordance with some embodiments of the present invention. The exhaust conduit 240 includes a central conduit 242 which may, for example, couple the processing volume 103 of the process chamber 102 to the abatement system 106. An annular, second conduit 244 may be disposed radially about a portion of the central conduit 242. The second conduit 244 may, for example, include a plurality of ports 246 for injecting a reactive species from the generator 108 (or from a fuel or reagent source, such as H2 gas or water vapor) into the central conduit 242. Alternatively, a plurality of second conduits may be provided at each port location about the central conduit 242.

In some embodiments, for example for local reagent generation, one or more electrodes (two electrodes 248 shown) may be disposed within the central conduit 242 and in close proximity to each other, or to some other suitable arcing surface. In the embodiment depicted in FIG. 2E, the two electrodes 248 are radially aligned and opposing each other and have a gap 250 disposed between their respective tips. The gap 250 may be any size suitable to maintain an arc between the electrodes 248 (or a single electrode and an arcing surface). For example, in some embodiments, the gap may be about 0.25 inches. Other gap sizes and electrode configurations may be utilized as well. The electrodes may be fabricated from any suitable materials, including tungsten and silicon nitride as non-limiting examples. In operation, the electrodes may be coupled to a power source (not shown) to form an arc between the electrodes. A reagent precursor gas (such as H2 gas or water vapor) may be provided via inlets 252, through ports 246, and into the central conduit 242, where the reagent precursor gas may be energized into a plasma to form one or more of singlet hydrogen, hydrogen radicals, hydroxyl radical, singlet oxygen, oxygen ions, or the like.

The above configuration described in FIG. 2E may be disposed in-line with the effluent exhaust conduit from the processing system (e.g., along the conduit between the process chamber 102 and the abatement system 106). Alternatively or in combination, the exhaust conduit 240 depicted in FIG. 2E may be disposed off-line and may be utilized to generate and introduce reagents via one or more of the embodiments discussed above. For example, the portion of the central conduit 242 labeled “from 102” may be capped and the portion of the central conduit labeled “to 106” may instead be routed to a conduit for providing the reactive species as discussed above, for example with respect to FIGS. 2A-D.

In some embodiments, an explosion prevention device may be provided. For example, the explosion prevention device (such as flash back flame arrestors) could be disposed within the reagent delivery conveyance systems or adjacent to points of injection. The explosion prevention device may be any suitable device or combination of devices for prevention of an explosive hazard. In addition, these devices can be of a technology that, upon sensing unwanted combustion, injects an inert gas upstream to stop flame propagation. This device could also be a technology that simply removes enough heat from said flame propagation to extinguish unwanted reactions. In other examples, the explosion prevention device may be at least one of a flashback arrestor, a check valve, an isolation valve, or some other one-way flow device. In addition, engineering design, pressure gradients, temperature control, and gas flow velocities can also or alternatively be used to manage local flammability issues in either or both of the exhaust conduit and abatement system.

The embodiments of exhaust conduits described above and depicted in FIG. 2A-E may be utilized individually or in combination to facilitate improved mixing of the reactive species and the effluents. In some embodiments, the exhaust conduit may further include an inert gas conduit (not shown) for injecting an inert gas into the exhaust conduit. The inert gas may facilitate minimizing deposition of effluent upon the conduit walls, and/or pump or other surfaces, and may further facilitate reducing the temperature of the effluent proximate the processing volume.

The abatement system 106 may be any suitable abatement system for receiving and processing the effluent from a process chamber, for example, the process chamber 102. One exemplary abatement system 106 is the Marathon abatement system, available from Applied Materials, Inc., of Santa Clara, Calif. Other abatement units may also be utilized. The abatement system 106 may be employed to abate a single process chamber or tool, or multiple process chambers and/or tools. The abatement system 106 may use, for example, thermal, wet scrubbing, dry scrubbing, catalytic, plasma and/or similar means for the treatment of the effluent, as well as processes for converting the effluent to less toxic forms. The abatement system 106 may further include multiple abatement systems for processing particular types of effluents from the process chamber 102.

An exemplary abatement system, for example, may include one or more of a scrubber, a thermal reactor (i.e., combustion reactor), a hydrogenation reactor, or the like. For example, the effluent exhausted from a chamber configured for etch processes may include halogens and/or halogen-containing molecules such as chlorine (Cl₂), nitrogen trifluoride (NF₃), and/or perfluorocompounds (PFCs) and unsaturated hydrocarbons, such as ethylene (C₂H₄) or propylene (C₃H₆). The effluent may be treated in the exhaust conduit 104 as discussed above, for example, to reduce the effluent into a more desirable form, or alternatively, the reactive species generator 108 can be coupled to the abatement system 104 to treat the effluent upon entering the abatement system 104.

The treated effluent, for example, may be initially injected into a thermal reactor, or combustor to further simplify the effluent into an exhaustible or treatable form. An effluent treated in a combustor may next be flowed into a scrubber, such as a liquid scrubber (i.e., water scrubber) or the like. For example, in water scrubbing, the effluent is brought into contact with water, using methods, such as bubbling the effluent through a water spray or the like. Some effluents, which are soluble in water may be removed by the scrubber. For example, an effluent such as HCl may be dissolved in water and removed from the effluent stream. In some embodiments, it may be necessary to provide a chemical additive to the scrubber, for instance, when the effluent foams. Foaming may limit effective removal of the effluent. Such a chemical additive may be provided by the inventive delivery apparatus 106, described in detail below with respect to FIG. 2. For example, a chemical additive used with a pre-scrubber may include an anti-foaming agent, such as Dow Corning anti-foamer 1410, or the like.

Effluent not removed by the scrubber, for example a saturated hydrocarbon, may be flowed into a thermal reactor (i.e., combustion reactor). Alternatively, in embodiments where the effluents do not require hydrogenation or scrubbing, the effluents may be flowed directly from the process chamber to the thermal reactor. An exemplary thermal reactor may, for example burn effluents, such as saturated hydrocarbons in an atmosphere of an oxygen-containing gas such as oxygen (O₂) to form carbon dioxide (CO₂) and water (H₂O) which can be released into the environment.

The abatement system described above is merely exemplary, and other abatement systems may benefit from the inventive methods and apparatus described herein. For example, a catalytic abatement system may be used, for example, in combination with a scrubber. A scrubber may be used prior to, or after an effluent is flowed into a catalytic reactor to remove gaseous or particulate components of the effluent that can damage, or reduce the effectiveness of, the catalytic reactor. The catalytic reactor may comprise a catalytic surface that catalyzes a reaction that converts the effluent into either an environmentally safe material, or a material that may be removed by, for instance, a scrubber or combustion reactor. The catalytic surface may be in the form of a structure made from catalytic material or supporting a finely divided catalyst, a bed of foam or pellets, or a coating on a wall or component of the catalytic reactor. The catalytic surfaces may be on, for example, a support structure comprising a ceramic material, such as cordierite, Al₂O₃, silicon carbide, silicon nitride, or the like.

In some embodiments, one or more energy recovery devices may also be utilized in the system to enhance overall efficiency of the entire system and further reduce the carbon footprint. Examples of energy recovery devices that can be employed include the cross exchange of thermal energy post abatement and using that recovered thermal energy to pre heat the effluent of the process chamber prior to reagent injection or prior to injection of effluent to the abatement system. Alternately, this recovered energy can be used to heat the chamber exhaust lines to minimize condensation of process chamber by-products in conveyance systems, vacuum pumps, and/or blowers. Other examples of thermal energy recovery include the cross exchange recovery of thermal energy and using that energy to feed ad or absorption chillers to minimize energy requirements in chilled water loops or use the waste heat to drive a sterling energy recovery engine. Thermal waste heat can also be used to make steam or drive a turbine.

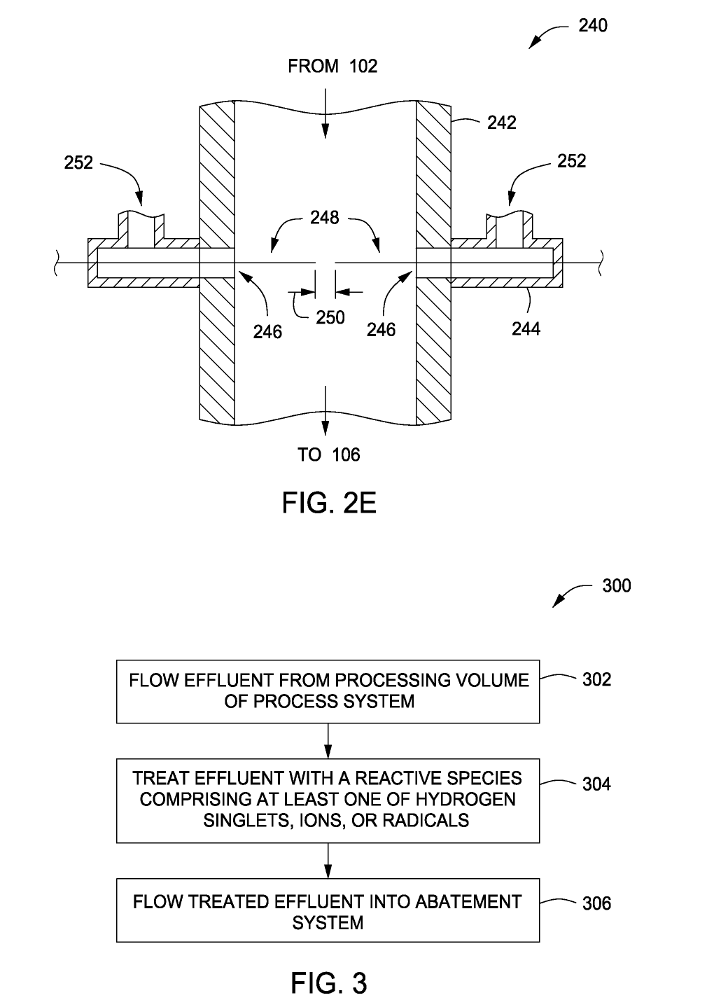

FIG. 3 depicts a flow chart of a method 300 for treating effluent in accordance with some embodiments of the present invention. The method 300 may be utilized with the embodiments of the process system 100 discussed in FIGS. 1 and 2A-E The method 300 includes flowing the effluent from the processing volume 103 of the process chamber 102 at 302. Next, at 304, the effluent may be treated with a reactive species formed from at least one of hydrogen gas (H₂) or water (H₂0). At 306, the treated effluent may be flowed into the abatement system 106 or otherwise removed from the exhaust system of the process chamber 102.

The inventive methods and apparatus described herein may advantageous provide local generation of a reactive species in, for example, the exhaust conduit of a process system. The inventive method and apparatus can improve abatement efficiency, and in some embodiments, improve abatement efficiency by unexpected amounts. For example, the inventors have discovered that when abating process effluent as discussed above, the hydrogen fuel abatement systems and processes discussed above could provide an about four times increased efficiency as compared to conventional abatement using methane as the abatement fuel. Further, the use of fuels, such as hydrogen (H₂) or water (H₂0), advantageously reduces the carbon foot print of the overall process. Further, the reactive species generated by such fuels may further advantageous reduce nitrogen oxides (NOₓ).

While the foregoing is directed to embodiments of the present invention, other and further embodiments of the invention may be devised without departing from the basic scope thereof.

1. A system for treating an effluent, comprising:
a process chamber having a processing volume;
an exhaust conduit coupled to the process chamber to remove an effluent from the processing volume; and
a reactive species generator coupled to the exhaust conduit to inject a reactive species into the exhaust conduit to treat the effluent, wherein the reactive species generator generates a reactive species comprising at least one of singlet hydrogen, hydrogen ions or hydrogen radicals.

2. The system of claim 1, further comprising:
an abatement system coupled to an opposing end of the exhaust conduit for receiving the treated effluent.

3. The system of claim 2, the exhaust conduit further comprising:
a vacuum pump disposed in the exhaust conduit for facilitating flow of the effluent through the exhaust conduit.

4. The system of claim 3, wherein the reactive species generator is coupled to the exhaust conduit either between the process chamber and the vacuum pump, at the vacuum pump, or between the vacuum pump and the abatement system.

5. The system of claim 2, further comprising:
a second conduit coupling the reactive species generator to the exhaust conduit, wherein the second conduit has a first end coupled to the reactive species generator and an opposing end disposed in the exhaust conduit to provide the reactive species to the exhaust conduit.

6. The system of claim 5, wherein a portion of the second conduit including the opposing end of the second conduit is disposed concentrically within the exhaust conduit.

7. The system of claim 2, wherein the exhaust conduit further comprises:
a first conduit having a first end coupled to the process chamber; and
a second conduit for receiving the effluent from an opposing end of the first conduit, wherein the second conduit has a first end for receiving the effluent from the first conduit and an opposing end coupled to the abatement system, and wherein the reactive species generator is coupled to the second conduit.

8. The system of claim 7, wherein a portion of the first conduit that includes the opposing end of the first conduit is disposed concentrically within a portion of the second conduit that includes the first end of the second conduit.

9. The system of claim 7, wherein the reactive species generator is coupled to the second conduit proximate the first end of the second conduit.

10. The system of claim 2, further comprising:
a second conduit coupling the reactive species generator to the exhaust conduit, wherein the second conduit has a first end coupled to the reactive species generator and an opposing end coupled to the exhaust conduit at a wall of the exhaust conduit to provide the reactive species to the exhaust conduit.

11. The system of claim 10, wherein the second conduit is disposed at an angle to the exhaust conduit to provide the reactive species to the exhaust conduit in a direction away from the process chamber.

12. The system of claim 2, wherein the exhaust conduit further comprises:
a first conduit having a first end coupled to the reactive species generator and an opposing end coupled to the abatement system; and
a second conduit having a first end coupled to the process chamber and a opposing end coupled to the first conduit at a wall of the first conduit.

13. The system of claim 12, wherein the second conduit is disposed at an angle to the first conduit to provide the reactive species to the exhaust conduit in a direction away from the reactive species generator.

14. The system of claim 2, further comprising:
a plurality of ports disposed radially about the exhaust conduit to inject the reactive species into the exhaust conduit.

15. The system of claim 14, wherein the exhaust conduit further comprises:
a second conduit disposed radially about a portion of the exhaust conduit and coupled to the plurality of ports.

16. The system of claim 14, further comprising:
an electrode having a tip extending into the exhaust conduit and positioned to define a gap between the electrode and an arcing surface, wherein the gap is suitable to sustain an arc when energy is applied to the electrode.

17. The system of claim 16, wherein the arcing surface is a second electrode disposed within the exhaust conduit.

18. A method for treating an effluent, comprising:
flowing an effluent from a processing volume of a process system through an exhaust conduit fluidly coupled to the processing volume;
treating the effluent in the exhaust conduit with a reactive species comprising at least one of singlet hydrogen, hydrogen ions, or hydrogen radicals; and
flowing the treated effluent to an abatement system.

19. The method of claim 18, wherein the reactive species further comprise at least one of hydrogen (H₂), oxygen (O₂), oxygen ions, oxygen radicals, oxyhydrogen (OH), oxyhydrogen radicals, or water (H₂O).

20. The method of claim 18, wherein the reactive species are formed from at least one of hydrogen gas or water.
